(19) United States
(12) Patent Application Publication
(10) Pub. No.: US 2008/0063927 A1
(43) Pub. Date: Mar. 13, 2008

(54) UNITARY ELECTRONIC DEVICE HOUSING MOLDING AND BATTERY BIASING MEMBER AND METHOD OF MAKING SAME

(75) Inventors: FELIPE A. VARELA, SUNRISE, FL (US); BACH L. NGUYEN, LAUDERHILL, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/531,456

(22) Filed: Sep. 13, 2006

(51) Int. Cl. H01M 2/10

(52) U.S. Cl. 429/97; 429/100

(57) ABSTRACT

A portable electronic device housing (100) is provided that can include a first molding (110) defining a battery compartment (120) and an internal cavity (130) and a second molding (140) disposed on the periphery of the first molding (110) and forming at least a portion of an outer surface (200) of the housing (100) and a biasing protrusion base (150) in the internal cavity (130). Additionally, a void (180) in the first molding (110) can be located at a side of the internal cavity (130) opposite to the battery compartment (120) where the void (180) provides an unsupported surface of the base (150). Still further, a battery biasing protrusion (160) unitary with the second molding (140) can be provided where the battery biasing protrusion (160) protrudes from the base (150) towards the battery compartment (120).

### CROSS REFERENCE TO RELATED APPLICATIONS

Not Applicable.

### FIELD OF THE INVENTION

This invention relates to molding of a mobile electronic device housing, and more particularly, to outer housing molding that is unitary with an internal battery biasing protrusion and the method for making the same.

### BACKGROUND

In recent years, mobile electronic products have become increasingly popular. The mobile telephone is one type of mobile electronic product that has become nearly ubiquitous in today's society. As such, mobile electronics manufactures have devised various methods of manufacturing and design arrangements for the mass production of the these devices to meet the ever increasing consumer demand.

At the same time, industry design considerations have been trending to the production of mobile electronic devices of decreasing thickness and overall size. To decrease the overall size of the electronic mobile devices, the components of these devices, and in particular, the internal components of these devices, have been proportionally decreased in overall size. Nevertheless, new challenges emerge as some of the internal components have been decreased to a size that introduces new issues and difficulties in arranging the components and connecting them to each other. In some instances, performance issues may arise, and in other instances, failure rates of certain components may increase.

By way of example, when certain components were of a relatively large size, these components could be connected by traditional coupling devices, such as a screw or the like. As the size of these components decreased, new arrangements were needed to connect the same components that are now too small for use with a screw or other similar coupling device. Accordingly, adhesives were introduced to fasten certain components that were previously fastened by one or more screws.

Although adhesives do provide an appropriate solution in some instances, in others, the use of adhesives has introduced new issues, such as lack of adhesion over time, or even misplacement or misalignment of the component with the adhesive. The problems associated with proper alignment and placement of components with adhesives increase when the size of the components are decreased to size where the small size of the components creates significant difficulties in handling the components. Still further, at this decreased size, even proper placement and quantities of adhesives does not always prevent failure at the surfaces of adhesion because the adhesive does not have a substantial amount of surface area to create a large enough bonded area. These issues are only exacerbated when the components to which adhesive is applied are movable, such as components that compress and expand during normal operation of the portable electronic device.

The marketplace lacks a solution for addressing issues created by the ever decreasing size of portable electronic devices and the components thereof. Moreover, new solutions are needed to ensure the connection of, and interaction of, the multitude of components of a portable electronic device. Furthermore, no solution previously presented for connecting components of electronic devices is suitable for the ever decreasing size of the components.

### SUMMARY OF THE INVENTION

Embodiments in accordance with the present invention provide a portable electronic device housing that addresses the limitations of the prior art. The housing can include a first molding defining a battery compartment and a second molding disposed on the periphery of the first molding and forming at least a portion of an outer surface of the housing. Still further, a battery biasing protrusion can be provided that is unitary with the second molding and is arranged such that the battery biasing protrusion protrudes towards the battery compartment. Additionally, the second molding can also provide a biasing protrusion base filling an internal cavity of the first molding, where the base is unitary with the battery biasing protrusion. In such an arrangement, the battery biasing protrusion is unitary with the battery biasing base, which are both unitary portions of the second molding.

In one embodiment in accordance with the inventive arrangements of the portable electronic device housing, the battery compartment can be at least partially defined by at least one wall, and the base can be substantially flush with the wall. In such an arrangement, the battery biasing protrusion can protrude from the base. Additionally, the first molding can also include a void located at a side of the internal cavity that is opposite to the battery compartment. As a result of the void, a surface of the base is unsupported and has sufficient space to allow for deflection.

In another embodiment in accordance with the inventive arrangements of the portable electronic device housing, the first molding can provide a battery biasing protrusion support member that is embedded in the base. Although the support member provides the support to the base, the support member can be flexible to allow for deflection of the base. In this regard, the battery biasing protrusion can be arranged to deflect in a direction opposite from the battery compartment. Additionally, the second molding can have an elastic modulus less than the elastic modulus of the first molding.

A method of manufacturing a portable electronic device housing with a molding is also provided in accordance with the inventive arrangements. The method can include the steps of providing a first molding of a first molding material, where the first molding defines a battery compartment and an internal cavity. Still further, the first molding can also provide a void located at a side of the internal cavity opposite to the battery compartment. In another step, a second molding material can be molded to the first molding at the periphery of the first molding and can fill the internal cavity with the second molding material. Still further, a battery biasing protrusion can protrude towards the battery compartment and can be formed of, and unitary with, the secondary molding. Additionally, the second molding material can have an elastic modulus that is less than the elastic modulus of the first molding material.

The above features and advantages of the present invention will be better understood with reference to the following figures and detailed description. It should be appreciated that the particular devices and methods illustrating the present invention are exemplary only and not to be regarded as limitations of the present invention.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a perspective view of one embodiment of a portable electronic device housing in accordance with an embodiment of the inventive arrangements;

FIG. 2A is a perspective view of an alternative embodiment of the portable electronic device housing;

FIG. 2B is a perspective view of the embodiment of FIG. 2A of the portable electronic device housing showing a second molding;

FIG. 3 is a perspective view of the embodiment of the portable electronic device housing of FIG. 1 with a second molding;

FIG. 4 is perspective view of the opposite of the embodiment of the portable electronic device housing of FIG. 1; and

FIG. 5 is a flow chart of a method in accordance with an embodiment of the inventive arrangements.

### DETAILED DESCRIPTION

While the specification concludes with claims defining the features of the embodiments of the invention that are regarded as novel, it is believed that the devices and method, and other embodiments will be better understood from a consideration of the following description in conjunction with the drawing figures, in which like reference numerals are carried forward.

As required, detailed embodiments of the present device and method are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiments herein.

The terms “a” or “an,” as used herein, are defined as one or more than one. The phrase “at least one of” as used herein, is defined as one or more than one. The term “another,” as used herein, is defined as at least a second or more. The terms “including” and/or “having,” as used herein, are defined as comprising (i.e., open language). As used in this application, the term “unitary” refers to structure that is a continuous whole unit without breaks or the fastening of two components. In contrast, a component that is created by coupling two separate components is a non-limiting example of a component that is not unitary. As also used in this application, the term “void” is a empty space through a structure. As also used in this application, the phrase “elastic modulus” refers to the measure of the stiffness of a given material. Further, the term “disposed” refers to the integration of one material, or component, with another through any suitable means of combing the same, including second shot molding, over molding and the like. Finally, the term “biased” or “biasing” refers to an arrangement of structure that creates a force in a particular direction.

The present invention provides a solution to the limitations of the prior art, which are becoming increasingly significant as mobile electronic devices are continuously trending to small and thinner devices. More specifically, the present invention provides for the replacement of parts that were previously mounted via screws, adhesives and the like and that could result in failures due to improper mounting or stress concentrations, with a section of a molding that is unitary with a large portion of the external molding. Unitary molding eliminates the problems associated with improperly placed separate parts and the ever increasing difficulty in arranging relatively small sized parts. Still further, a method of manufacturing mobile electronic devices to include such unitary molding is also provided.

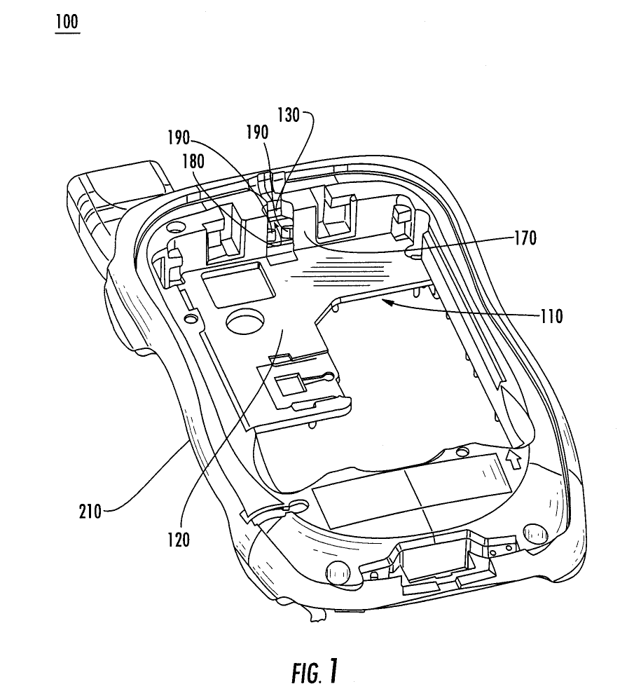

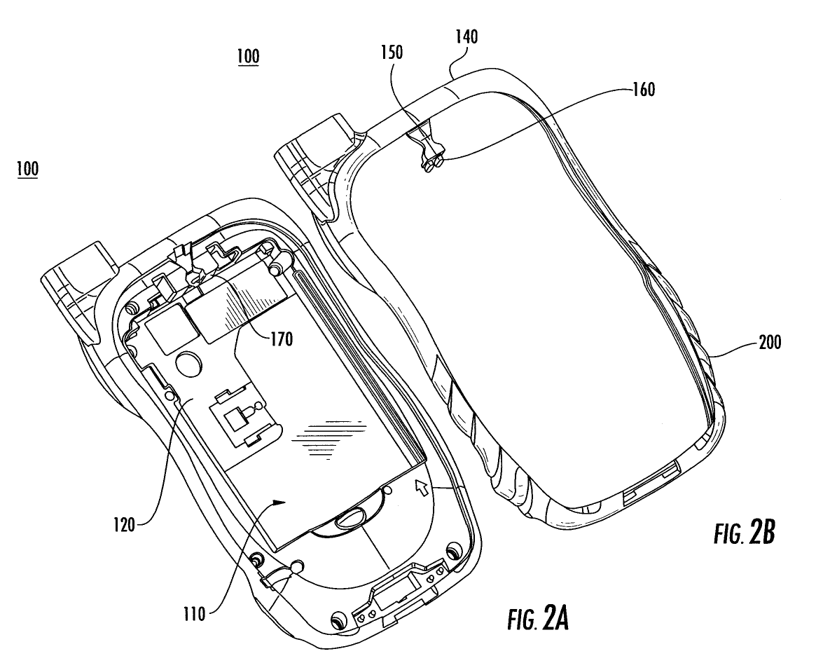

By reference to the exemplary drawings in detail wherein like numerals indicate like elements throughout the various views, there is shown in FIGS. 1, 3 and 4 an exemplary electronic device housing with a first molding and second molding in accordance with the invention. There is shown in FIGS. 2A and 2B another embodiment of an exemplary electronic device housing with a first molding and second molding labeled with the same reference numbers as FIGS. 1, 3 and 4. The electronic device housing 100 can include a first molding 110 with a battery compartment 120 and an internal cavity 130. The electronic device housing 100 can also include a second molding 140 that forms base 150 and a battery biasing protrusion 160.

The first molding 110 provides a variety of internal support structures for various components of the electronic mobile device, such a subscriber identification module card holder, and has a periphery 210 that serves a base to which at least a portion of the second molding 140 is disposed. The first molding 110 can provide structural support to the overall housing 100, and thus, can be constructed of a material with a greater elastic modulus than other components of the housing 100, including the second molding 140. Non-limiting examples of such materials include thermoplastic materials, such as polystyrene or acrylonitrile butadiene styrene.

The first molding 110 provides the battery compartment 120, in which the battery is retained. Portions of the first molding 110 provide one or more walls 170 that define the battery compartment 120. The size of the battery compartment 120 can vary as needed dependent upon the battery to be housed and the overall size of the housing 100.

The first molding 110 also provides the internal cavity 130, which is an open volume of space adjacent to the wall 170 that the defines the battery compartment 120. The internal cavity 130 is shown in FIG. 1 with at least two side walls and an open side that is flush with the wall 170 and adjacent to the battery compartment 120. On side of the internal cavity 130 opposite the open side that is flush with the battery compartment 120, the boundary of the internal cavity 130 is established partially by a void 180 in the first molding 110. The void 180 provides an open space adjacent to the internal cavity 130 and opposite to the battery compartment 120.

Additionally, the first molding 110 can provide battery biasing protrusion support members 190 that extend at least partially across the internal cavity 130. These support members 190 can be constructed to be flexible to allow some bending at least away from the battery compartment 120.

The second molding 140 can be disposed on the first molding 110 in a variety of manners to provide at least a portion of the outer surface 200 of the electronic device housing 100. The second molding 140, including all of its various portions, can be a unitary construction of one member, obviating any need to join two or more pieces together. In addition to forming portions of the outer surface 200, the second molding 140 can fill internal cavity 130 with biasing protrusion base 150 and provide battery biasing protrusion 160. The second molding 140 can be formed of similar materials to those that form the first molding 110; however, the elastic modulus of the material of the second molding 140 can be less than the elastic modulus of the first molding 110, to provide an ability to deflect or to be compressed to a greater degree.

The biasing protrusion base 150 can be substantially flush with the wall 170 of the battery compartment 120. The base 150 can abut against, or have embedded therein, the support members 190 to resist forces pushing the base 150 away from the battery compartment 120. Nevertheless, the side of the base 150 that is opposite the battery compartment 120 is adjacent to void 180, and is thus an unsupported side of the base 150. This unsupported side of base 150 allows the base 150 to flex or deflect into the void 180, if needed.

The base 150 provides support for, and the surface from which, the battery biasing protrusion 160 protrudes towards the battery compartment 120. The protrusion 160 can be of any suitable size or shape for being engaged by the battery during and after insertion of the battery and ensuring that the battery is maintained in the battery compartment 120. With the battery inserted, the protrusion 160 is compressed in the direction towards the base 150 and the protrusion 160, the base 150, and even the support members 190 can be deflected or compressed away from the battery compartment 120.

There is shown in FIGS. 2A and 2B another embodiment in accordance with the inventive arrangements. FIG. 2A illustrates the first molding 110 separate from the second molding 140, which is shown in FIG. 2B. FIG. 2B clearly depicts the second molding 140 as being unitary with the base 150 and protrusions 160. In this arrangement, two battery biasing protrusions 160 are extended from base 150. Two or more biasing protrusions 160 can provide additional support; however, any number of suitable protrusions 160, arranged at one or more locations to protrude into the battery compartment, can be provided.

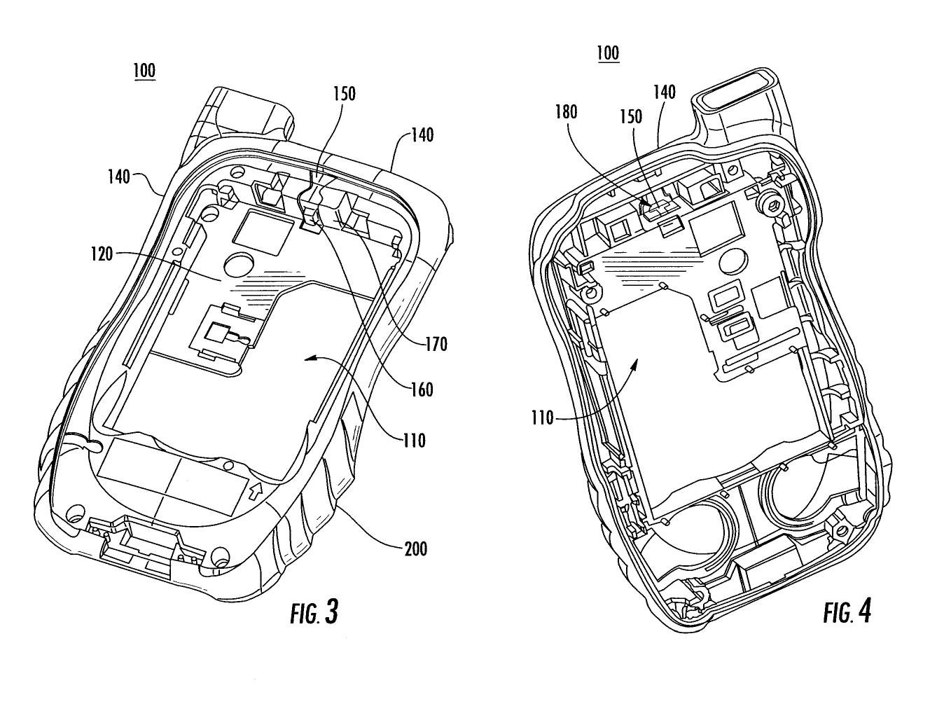

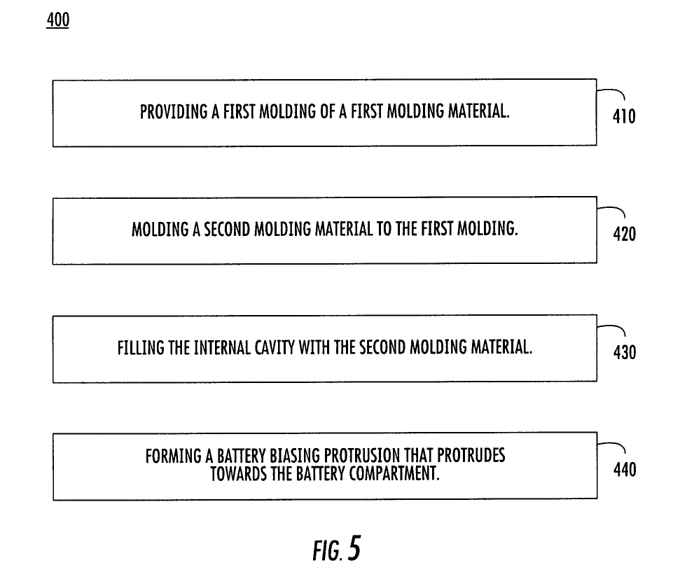

The present invention also provides a method 400 of manufacturing a portable electronic device housing with a molding. The steps of the method are illustrated in a flow chart shown as FIG. 4. Although the flow chart illustrates the steps of method 400 in sequential order, there is no requirement as to the order of the steps, whether some steps are completed or skipped, or whether additional steps can be added.

In step 410, a first molding of a first molding material is provided, where the first molding defines a battery compartment and an internal cavity, and further provides a void located at a side of the internal cavity opposite to the battery compartment. The first molding can be created during a two shot molding process; however, such a process is not necessary for completion of method 400. Method 400 contemplates both the creation of the first molding and starting method 400 with a preformed first molding.

In step 420, a second molding material can be disposed on the first molding at the periphery of the first molding. The disposing of the second molting material can occur at elevated temperatures and pressures to ensure proper distribution of the second molding material.

It should be noted that steps 410 and 420 can be combined by means of successive molding methods. With successive methods, the steps can include injection molding one part, transferring this part to a second mold as an insert, and molding the second component against the first. One example of such successive methods includes injecting molten plastic at an elevated pressure into a mold, which is the inverse of the desired shape.

In step 430, the internal cavity can be filled with the second molding material. Again, this step can be combined with steps 410 and 420 and can occur with the second molding material under pressure and at elevated temperature.

In step 440, a battery biasing protrusion that protrudes towards the battery compartment can be formed. This protrusion can be formed by placing the first molding in a second mold and introducing a thermoplastic into the open areas. The protrusion remains after the thermoplastic cools and the second mold is removed.

This invention can be embodied in other forms without departing from the spirit or essential attributes thereof. For instance, although the electronic device housing is shown as a mobile phone, one skilled in the art would readily recognize that the invention can be used with a wide variety of electronic devices, such as radios, personal digital assistants, micro computers, and the like. Accordingly, reference should be made to the following claims, rather than to the foregoing specification, as indicating the scope of the invention.

We claim:

1. A portable electronic device housing, comprising:
a first molding defining a battery compartment;
a second molding disposed on the periphery of the first molding and forming at least a portion of an outer surface of the housing;
a battery biasing protrusion unitary with the second molding; and
wherein the battery biasing protrusion protrudes towards the battery compartment.

2. The portable electronic device housing according to claim 1, wherein the second molding provides a biasing protrusion base filling an internal cavity of the first molding, the base being unitary with the battery biasing protrusion.

3. The portable electronic device housing according to claim 2, wherein the battery compartment is defined by at least one wall, the base being substantially flush with the wall and the battery biasing protrusion protruding from the base.

4. The portable electronic device housing according to claim 3, the first molding further comprising a void located at a side of the internal cavity opposite to the battery compartment, the void providing an unsupported surface of the base; and
whereby the void provides space for deflection of the base.

5. The portable electronic device housing according to claim 2, wherein the first molding provides a battery biasing protrusion support member embedded in the base.

6. The portable electronic device housing according to claim 5, wherein the battery biasing protrusion support member is flexible.

7. The portable electronic device housing according to claim 1, wherein the battery biasing protrusion is arranged to deflect in a direction opposite from the battery compartment.

8. The portable electronic device according to claim 1, wherein the second molding has an elastic modulus less than the elastic modulus of the first molding.

9. A portable electronic device housing, comprising:
a first molding defining a battery compartment and an internal cavity;
a second molding disposed on the periphery of the first molding and forming at least a portion of an outer surface of the housing and a biasing protrusion base in the internal cavity;
a void in the first molding and located at a side of the internal cavity opposite to the battery compartment, the void providing an unsupported surface of the base;
a battery biasing protrusion unitary with the second molding; and
wherein the battery biasing protrusion protrudes from the base towards the battery compartment.

10. The portable electronic device housing according to claim 9, wherein the first molding provides a battery biasing protrusion support member embedded in the base.

11. The portable electronic device housing according to claim 10, wherein the battery biasing protrusion support member is flexible.

12. The portable electronic device according to claim 1, wherein the second molding has a elastic modulus less than the elastic modulus of the first molding.

13. A method of manufacturing a portable electronic device housing with a molding, the method comprising the steps of:
providing a first molding of a first molding material, the first molding defining a battery compartment and an internal cavity and providing a void located at a side of the internal cavity opposite to the battery compartment;
molding a second molding material to the first molding at the periphery of the first molding;
filling the internal cavity with the second molding material; and
forming a battery biasing protrusion that protrudes towards the battery compartment.

14. The method of manufacturing according to claim 13, wherein the second molding material has an elastic modulus that is less than the elastic modulus of the first molding material.
